(19) United States
(12) Patent Application Publication
(10) Pub. No.: US 2026/0111714 A1
(43) Pub. Date: Apr. 23, 2026

(54) Model Compression using Weights that Express Differences between Model Parts

(71) Applicant: Microsoft Technology Licensing, LLC, Redmond, WA (US)

(72) Inventors: Mohsen FAYYAZ, Berlin (DE); Parth Sandip PATHAK, London (GB); Liana MIKAELYAN, London (GB); Ayyoob IMANIGOOGHARI, Munich (DE)

(73) Assignee: Microsoft Technology Licensing, LLC, Redmond, WA (US)

(21) Appl. No.: 18/922,468

(22) Filed: Oct. 22, 2024

(51) Int. Cl. G06N 3/0495; G06N 3/0455; G06N 3/096

(52) U.S. Cl. CPC G06N 3/0495; G06N 3/0455; G06N 3/096

(57) ABSTRACT

A technique compresses a pretrained model having a sequence of model parts that produce output results of the same shape, to produce a compressed model. The technique includes converting the pretrained model into a difference-based model having instances of difference-based weights, converting the difference-based model into a reduced-dimension model having instances of reduced-dimension weights, and then fine-tuning the reduced-dimension model. Each instance of difference-based weights expresses the difference between neighboring instances of full weights in the pretrained model. The execution of the compressed model includes generating an instance of full weights associated with a particular fine-tuned model part of the compressed model. This is performed by combining instances of weights associated with different levels of the compressed model. The technique significantly reduces the amount of resources that are required to store and run a machine-trained model.

### BACKGROUND

An increasing number of applications incorporate machine-trained models, such as language models. However, this type of technology is resource-intensive in nature. This makes it technically challenging for an application to locally implement a machine-trained model. For instance, a local execution platform may not have sufficient storage and memory capacity to feasibly store and execute a large machine-trained model. Further, it requires a significant amount of time for a local execution platform to download the weights of a large machine-trained model from a network-accessible source.

### SUMMARY

A technique is described for compressing a pretrained model having a sequence of model parts that produce output embeddings of the same shape (e.g., the same dimensions), to produce a compressed model. Each model part in the pretrained model has an instance of full weights. The technique includes (1) converting the pretrained model into a difference-based model having instances of difference-based weights, (2) converting the difference-based model into a reduced-dimension model having instances of reduced-dimension weights, and then (3) fine-tuning the reduced-dimension model. Each instance of difference-based weights expresses the difference between two instances of full weights at two successive levels in the pretrained model. Each instance of reduced-dimension weights is formed by reducing the amount of information in an instance of difference-based weights, while retaining the most salient information. In some implementations, dimension reduction is also applied to the instance of full weights.

In some implementations, the pretrained model is a pretrained transformer-based model having a sequence of transformer blocks.

In some implementations, the compressed model includes at least one anchor model part that includes a fine-tuned version an instance of full weights.

In some implementations, the conversion of the difference-based model into the reduced-dimension model uses singular value decomposition (SVD) to reduce the dimensionality of the instances of at least the difference-based weights.

In some implementation, the technique further includes storing the compressed model in a data store of a computing device, such as a user computing device. For example, the technique stores the component matrices produced by SVD. The computing device locally executes the compressed model.

In some implementations, the execution of the compressed model includes, at runtime, computationally reconstructing instances of full weights based on the respective instances of reduced-dimension weights. This is performed by combining instances of weights at different levels of compressed model in the course of performing computations. This reconstruction does not necessitate actually storing the reconstituted full weights in RAM memory.

According to illustrative technical effects, the compressed model is significantly reduced in size compared to the pretrained model. The amount of storage space (e.g., disk storage space) required to store the compressed model is therefore much less than the amount of storage space required to store the pretrained model. Similarly, the amount of memory required to execute the compressed model is much less than the amount of memory required to execute the pretrained model. Further, the compressed model has fewer parameters compared to the pretrained model. By using fewer parameters, the execution process in the forward pass is able to perform fewer computations using the compressed model compared to the pretrained model. This speeds up inference. Overall, the reduction in resource demands expands the types of computing devices that are capable of running machine-trained models.

The above-summarized technology is capable of being manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows an example of three stages in the compression of a pretrained model.

FIG. 2 is a flowchart that shows a process for producing the results of FIG. 1. The process yields a compressed model.

FIG. 3 shows a computing device for executing a compressed model produced by the process of FIG. 2.

FIG. 4 shows an example of a first implementation of a weight-generating operation that is performed in the execution of the compressed model.

FIG. 5 shows an example of a second implementation of the weight-generating operation that is performed in the execution of the compressed model.

FIG. 6 shows a transformer-based language model that includes a sequence of transformer blocks. The transformer-based language model is an example of a pretrained model that is capable of being compressed by the compression process of FIG. 2.

FIG. 7 shows a data structure provided by a source system (and/or a local system) for representing instances of weights of a machine-trained model. Part of the weights associated with this data structure represents a compressed model produced by the process of FIG. 2.

FIG. 8 shows a model part that relies on an instance of base model weights obtained from the data structure of FIG. 7.

FIG. 9 shows a model part that relies on an instance of inter-path-variance weights in conjunction with an instance of base model weights, both obtained from the data structure of FIG. 7.

FIG. 10 shows an execution framework for downloading instances of weights from a source system to a local system, and executing a machine-trained model at the local system based on the instances of weights.

FIG. 11 shows a model part that relies on weight information represented by the data structure of FIG. 7.

FIG. 12 is a flowchart that describes a process of compressing a pretrained model into a compressed model.

FIG. 13 is a flowchart that describes a process for executing a compressed model produced by the process of FIG. 12.

FIGS. 14 and 15 shows illustrative computing systems that, in some implementations, are used to implement any aspect of the features shown in the foregoing drawings.

The same numbers are used throughout the disclosure and figures to reference like components and features.

### DETAILED DESCRIPTION

### A. Model-Compression Process

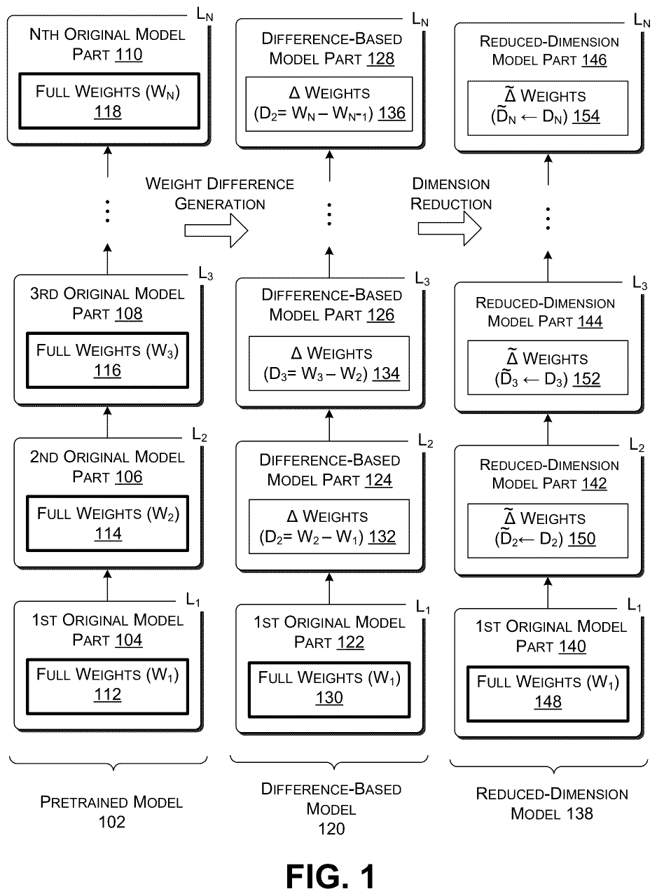

FIG. 1 shows an example of a process for compressing a pretrained model 102. The pretrained model 102 is a neural network including a sequence of N model parts (104, 106, 108, . . . , 110) at N respective levels of the neural network. Each model part includes one or more layers of the neural network that perform a particular function. The different model parts produce output results having the same shape (e.g., the same dimensionality), making the results readily comparable and combinable. Each of the model parts (104, 106, 108, . . . , 110) include respective instances of full weights (112, 114, 116, . . . , 118), in which each instance of weights is denoted by Wᵢ, where i is the level. Note that, in some implementations, the model parts (104, 106, 108, . . . , 110) perform the same function, but this is not necessary so long the model parts (104, 106, 108, . . . , 110) produce same-sized output results.

For example, the pretrained model 102 is a transformer-based language model, and the model parts (104, 106, 108, . . . , 110) are transformer blocks of the transformer-based language model. Each individual transformer block includes a set of machine-trained weights that implement the functions of the transformer block (e.g., attention operations, normalization operations, and feed-forward operations). Other examples of pretrained models include convolutional neural networks (CNNs), recurrent neural networks (RNNs), diffusion networks, etc.

In a first transformation, the process converts the pretrained model 102 into a difference-based model 120. The difference-based model 120 includes a sequence of model parts including a first model part 122 and plural subsequent difference-based model parts (124, 126, . . . , 128). In some examples, the first model part 122 retains the same set of full weights 130 as the first original model part 104 of the pretrained model 102. The difference-based model parts (124, 126, . . . , 128) include respective instances of difference-based weights (132, 134, 136), each denoted by Dᵢ. Each instance of difference-based weights is produced by generating the difference between two instances of full weights at two successive levels of the pretrained model, or, more generally, between two identified levels.

For example, the second-level difference-based model part 124 includes an instance of difference-based weights 132 that expresses a difference between the instances of full weights (114, 112) at levels L₂ and L₁ of the pretrained model (given by D₂=W₂−W₁). The third-level difference-based model part 126 includes an instance of difference-based weights 134 that expresses a difference between the instances of full weights (116, 114) at levels L₃ and L₂ of the pretrained model 102 (given by D₃=W₃−W₂). The Nth-level difference-based model part 128 includes an instance of difference-based weights 136 that expresses a difference between the instances of full weights at levels L_{N} and L_{N-1} of the pretrained model 102 (given by D_{N}=W_{N}−W_{N-1}).

In a second transformation, the process converts at least the difference-based model 120 into a reduced-dimension model 138. The reduced-dimension model 120 includes a sequence of model parts including a first model part 140 and plural subsequent reduced-dimension model parts (142, 144, . . . , 146). The first model part 140 retains the same set of full weights 148 as the first original model part 104 of the pretrained model 102 (or a reduced-dimension version thereof). The reduced-dimension model parts (142, 144, . . . , 146) include respective instances of reduced-dimension weights (150, 152, 154), each given by \tilde{D}ᵢ. Each instance of reduced-dimension weights is generated by reducing the amount of information in a counterpart instance of difference-based weights.

For example, the second-level reduced-dimension model part 142 includes an instance of reduced-dimension weights \tilde{D}₂ 150 that expresses an information-reduced version of the instance of difference-based weights D₂ 132. The third-level reduced-dimension model part 144 includes an instance of weights \tilde{D}₃ 152 that expresses an information-reduced version of the instance of difference-based weights D₃ 134. The Nth-level reduced-dimension model part 146 includes an instance of weights \tilde{D}_{N} 152 that expresses an information-reduced version of the instance of difference-based weights D_{N} 136.

The process forms each instance of reduced-dimension weights using any low-rank information-reduction technique, including any of singular value decomposition (SVD), principal component analysis (PCA), linear discriminant analysis (LDA), etc. For example, SVD reduces an original given m×n matrix A into a product of three smaller component matrices U, S, and V, as given by A=U*S*V^{T} (where T represents transposition). U and V are orthonormal matrices of sizes m×m and r×n, respectively, and S is a diagonal matrix of size m×r. The symbol r specifies the rank of matrix A. From a high-level perspective, SVD captures the most salient information in the original matrix A, eliminating the remainer of the information as noise. The amount of information to be retained in matrix A is given by the rank r. Several publicly-accessible computer languages and platforms include functions that implement SVD, including PyTorch, MATLAB (produced by MathWorks), C, etc.

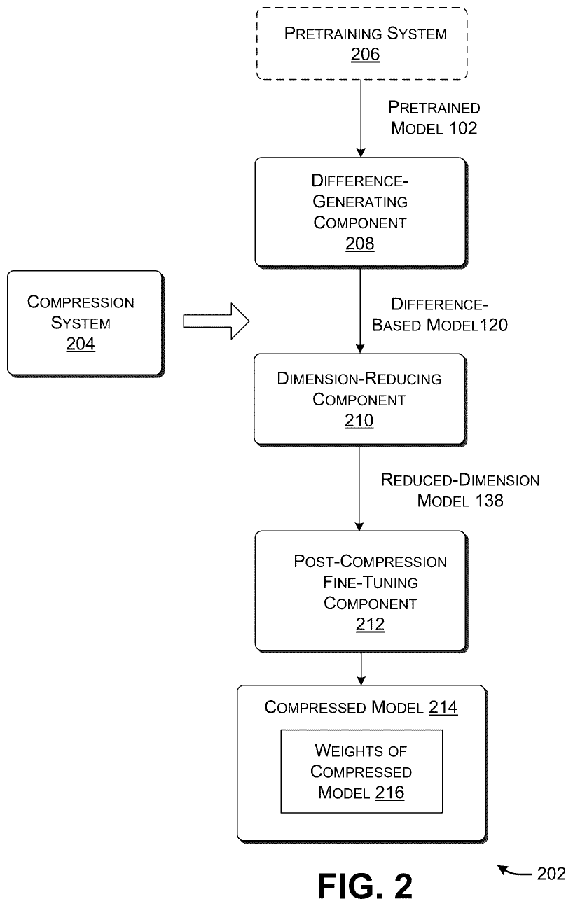

FIG. 2 shows an overview of a process 202 for performing the transformation shown in FIG. 1. A compression system 204 performs the process 202. One or more computing devices implement the compression system 204. In some implementations, the compression system 204 performs the entirety of the process 202 using network-accessible servers. In other implementations, the compression system 204 implements the entirety of the process 202 at a local computing device. In other implementations, the compression system 204 implements the process using a combination of network-accessible and local computing resources.

The process 202 begins by receiving the pretrained model 102. In some examples, the pretrained model 102 is a pretrained generative language model. A pretraining system 206 produces the pretrained model 102 based on any training objective. For example, the pretraining system 206 pretrains a generative language model by performing unsupervised training using language modeling (e.g., predicting the next word in a given text passage and comparing the prediction with the actual next word) and by performing supervised training (e.g., predicting an output result and comparing the prediction with a ground-truth result). Background on the general task of pretraining generative language models is provided in Radford, et al., “Improving Language Understanding by Generative Pre-training,” OpenAI, San Francisco California, Jun. 11, 2018, 12 pages. One example of a publicly available pre-trained language model is described in Touvron, et al., “LLaMA: Open and Efficient Foundation Language Models,” arXiv, arXiv:2302.13971v1 [cs.CL], Feb. 27, 2023, 27 pages. Another example of a publicly available pretrained language model is described in Abdin, et al., “Phi-3 Technical Report: A Highly Capable Language Model Locally on Your Phone,” arXiv, arXiv:2404.14219v4 [cs.CL], Aug. 30, 2024, 24 pages.

A difference-generating component 208 transforms the pretrained model 102 into the difference-based model 120. As set forth with respect to FIG. 1, the difference-generating component 208 produces each instance of difference-based weights by generating a difference between two instances of full weights at two successive levels of the pretrained model 102.

A dimension-reducing component 210 transforms the difference-based model 120 into the reduced-dimension model 138. As set forth above, the dimension-reducing component 210 performs this task by identifying and preserving the most salient parts of the difference-based weights. One approach for performing this task is SVD. The amount of noise reduction achieved by SVD is given by the rank r. The dimension-reducing component 210 stores the Uᵢ, Sᵢ, and Vᵢ matrices produced by SVD for each instance of difference-based weights Dᵢ at each level i, instead of the original difference-based weights Dᵢ for this level. These component matrices are smaller than the original matrix for the difference-based weights Dᵢ.

Note that the process 202 presents the difference-generating component 208 and the dimension-reducing component 210 as two distinct functionalities that operate in succession. But in other implementations, a single component integrates the difference-generating operations and the dimension-reducing operations in a more seamless way.

Further note that, in the implementation depicted in FIGS. 1 and 2, the dimension-reducing component 210 produces reduced-dimension weights for the difference-based weights, but not the instance of full weights. In other implementations, the dimension-reducing component 210 produces reduced-dimension weights for the instance of full weights too. Any mention of a fine-tuned instance of the full weights herein is to be understood as encompassing both an implementation in which the full weights are also dimension-reduced, and an implementation in which the full weights are not dimension-reduced.

A post-compression fine-tuning component 212 fine-tunes the reduced-dimension model 128, to produce a compressed model 214 having weights 216. The process 202 generally performs fine-tuning to recapture useful knowledge that may have been lost in the weight compression performed by the dimension-reducing component 210. In some implementations, the post-compression fine-tuning component 212 performs fine-tuning to improve the ability of the compressed model 214 to perform a particular task. The post-compression fine-tuning component 212 achieves this result by performing supervised learning, given a set of training examples that are pertinent to the task. The positive training examples in the set specify input items and associated ground-truth results that are assessed as correct responses to the input items. Over plural iterations, the post-compression fine-tuning component 212 computes model-generated results based on the input items, compares the model-generated results with the ground-truth results, and adjusts the weights of the compressed model 214 to reduce future discrepancies between the model-generated results and the ground-truth results. The post-compression fine-tuning component 212 uses any loss function to assess discrepancies, such as cross entropy.

In some implementations, the process 202 uses one more additional techniques to reduce the size of a model. These techniques include knowledge distillation, pruning, and quantization. The process 202 invokes any one of these techniques at any stage. In some cases, for instance, the process 202 performs one or more of these techniques on the pretrained model 102, prior to the compression described in FIG. 2. Alternatively, or in addition, the process 202 performs any one of these techniques on the compressed model 214.

Knowledge distillation uses a machine-trained teacher model to assist in training a smaller student model. By this process, the knowledge of the more powerful—but more resource-intensive—teacher model is transferred to (or distilled in) the smaller and more resource-efficient student model. Pruning operates to eliminate parameter values that have the least impact on the operation of a machine-trained model. Quantization reduces the size of parameter values by changing the format used to express the parameter values, e.g., by converting floating point information into integer form. General background information on the topic of model size reduction can be found in Xu, et al., “A Survey on Model Compression and Acceleration for Pretrained Language Models,” arXiv, arXiv:2202.07105v2 [cs.CL], Nov. 29, 2022, 10 pages.

The compressed model 214 has fewer parameters compared to the original pretrained model 102 and has a greatly reduced size compared to the original pretrained model. This makes it more feasible to store a machine-trained model on a hard disk of a typical consumer computing device. For example, without compression, some language models consume well over 100B gigabytes of storage space. This makes it challenging for a typical consumer device (which, for instance, may have a capacity of one terabyte) to store a language model. Note, however, that the compressed model 214 may have more parameters than the initial pretrained model 102.

### B. Computing Device for Executing the Compressed Model

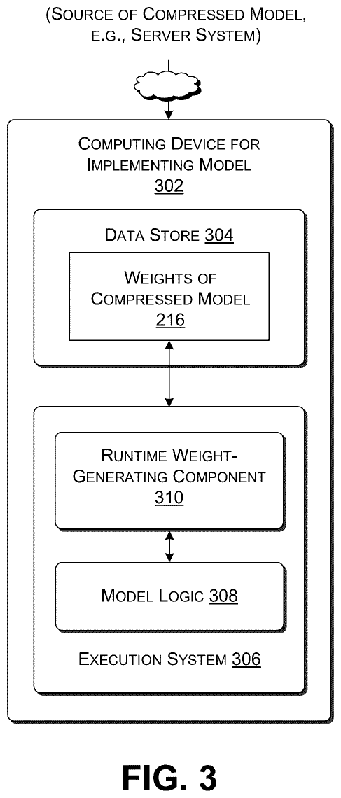

FIG. 3 shows a computing device 302 for executing the compressed model 214. In some examples, the computing device 302 is a user computing device of any type, including any of a desktop computing device, a laptop computing device, a handheld computing device of any type (e.g., a smartphone or a tablet-type computing device), a mixed reality device, an intelligent appliance, a wearable computing device (e.g., a smart watch), an Internet-of-Things (IoT) device, a gaming system, vehicle-borne computing system, any type of robot computing system, and so on. In other examples, the computing device 302 is one or more servers of a network-accessible system.

Assume that the former implementation applies, in which case the computing device 302 is some type of local computing device that implements the compressed model 214 in local fashion. The computing device 302 receives the weights 216 of the compressed model 214 (or the entire compressed model 214 including its machine-readable instructions) from a source system (e.g., a network-accessible system). The receipt of the weights 216 is initiated by the computing device 302 in response to a request for the weights 216. Alternatively, the source system independently pushes the weights 216 to the computing device 302. Alternatively, the computing device 302 is produced and distributed with a complete copy of the compressed model 214 and its weights 216, which avoids the need for downloading the compressed model 214 and its weights 216. However, the computing device 302 can then receive corrective patches to the compressed model 214 as they become available.

The computing device 302 stores the weights 216 in a data store 304. The data store 304 is intended to broadly encompass different types of storage devices used in different contexts. In some contexts, the data store 304 represents any storage device (e.g., a disk or static hard drive) for storing the compressed model on a long-term basis. In other contexts, the data store 304 is any type of memory (e.g., a RAM) for storing portions of the weights 216 during the execution of the compressed model 214.

An execution system 306 executes the compressed model 214 in the data store 304. The execution system 306 represents any type of execution framework, including a central processing unit or some type of accelerator. The accelerator performs the specialized task of efficiently executing the operations of a machine-trained model. Examples of accelerators include a graphics processing unit, a neural processing unit, an application-specific processing unit, etc.

The execution of the compressed model 214 involves retrieving portions of the weights 216 from the data store 304 and performing operations using model logic 308. In a transformer-based model, for example, the model logic 308 represents machine-readable instructions for performing the various attention, normalization, and feed-forward computations of each transformer block.

Note that most of the weights 216 of the compressed model 214 are initially in compressed form. A runtime weight-generating component 310 restores each instance of reduced-dimension weights to an associated full version of weights on an on-needed basis in the course of performing computations. This type of reconstitution is an ephemeral byproduct of the computations which does not necessitate interacting with RAM memory to store and retrieve full weights (thereby effectively bypassing interaction with the RAM). For instance, in the course of executing the operations of a particular transformer block of a transformer-based model, the runtime weight-generating component 310 reconstitutes a full version of weights for this transformer block without formally committing these weights to RAM memory. This manner of operation reduces the amount of memory used during execution of the compressed model. The execution system 306 is also able to perform fewer computations using the compressed model 214 compared to the pretrained model 102 because the compressed model 214 has fewer parameters compared to the pretrained model 102. By using fewer parameters, the execution system 306 is also able to spend less time storing and retrieving information from memory. These factors speed up inference.

In other implementations, however, the runtime weight-generating component 310 restores larger portions of weights in advance of their use and stores the reconstituted weights in memory. For instance, some implementations expand all of the reduced-dimension weights prior to the start of model execution. This implementation will still have the benefit of reducing the amount of space necessary to store the compressed model 214 on a long term basis.

Note that the full version of weights will not be the exact duplicate of a corresponding instance of full weights in the pretrained model 102. This is because some information is lost in the process of producing the reduced-dimension weights. Also, the weights are fine-tuned after compression by the post-compression fine-tuning component 212, which adjusts their values.

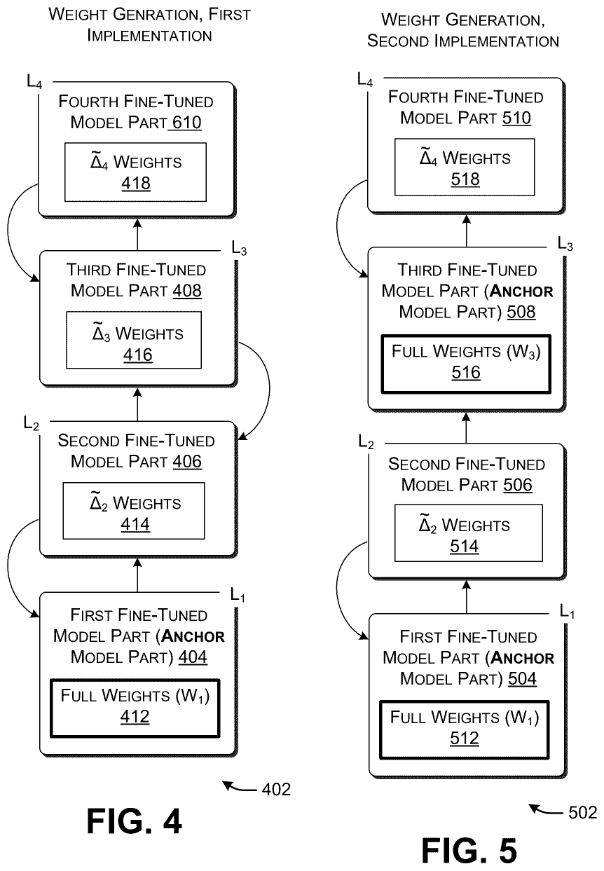

FIGS. 4 and 5 show two implementations of the operation of the runtime weight-generating component 310. Assume that the compressed model 402 includes four fine-tuned model parts (404, 406, 408, 410) at four respective levels that store four respective instances of weights (412, 414, 416, 418). Assume that the first fine-tuned model part 404 stores the only instance of full weights 412 in the compressed model 402, in which the instance of full weights 412 may be dimension-reduced in some implementations and not dimension-reduced in other implementations. This model part is also referred to herein as an anchor model part because it serves as a reference in restoring versions of full weights for the other model parts. The remainder of the fine-tuned model parts (406, 408, 410) store instances of reduced-dimension weights (414, 416, 418). The inclusion of four levels is illustrative, and other compressed models include additional or fewer levels.

The process of restoring a full version of weights for any instance of reduced-dimension weights for a difference-based model part is based on the summation of instances of weights at different levels, which is performed in one or more summation operations. For instance, assume that the task is to restore a full version of weights for the fourth fine-tuned model part 410. The runtime weight-generating component 310 sums the instances of weights associated with the all four model parts (404, 406, 408, 410).

For the particular case of SVD composition, the above-described summation operations are preceded by operations in which, at each level i, the Uᵢ, Sᵢ, and Vᵢ component matrices of \tilde{D}ᵢ are multiplied together (U*S*V^{T}) to construct an instance of difference-based weights Dᵢ. This reconstruction is also applied to the anchor model part if it has been compressed using SVD.

FIG. 5 shows a compressed model 502 having four fine-tuned model parts (504, 506, 508, 510) at different respective levels. The fine-tuned model parts (504, 506, 508, 510) include respective instances of weights (512, 514, 516, 518). The compressed model 502 differs from the fine-tuned model by including two anchor model parts (504, 508) at the first and third levels of the compressed model 502 (instead of a single anchor model part 404 as is the case in the compressed model 402). The runtime weight-generating component 310 operates in the same manner described above, except that the chain of weight-generating operations stops whenever a full version of weights is encountered. For example, in the process of restoring a full version of weights for the fourth fine-tuned model part 510, the runtime weight-generating component 310 need only refer to the full version of weights 516 provided by the anchor model part 508 (compared to the more complex chain of dependency that is involved in restoring weights in the example of FIG. 4). More generally, any compressed model is capable of incorporating any number of anchor parts, and the restoration of weights for any instance of reduced-dimension weights can include any number of “hops” to reach an instance of full weights associated with an anchor part. Increasing the number of anchor parts in a chain of model parts reduces the amount of compression, but also improves the quality of the output results. This is because increasing the amount of full weights reduces the loss associated with representing weights using difference-based information.

### C. Example of a Pretrained Model

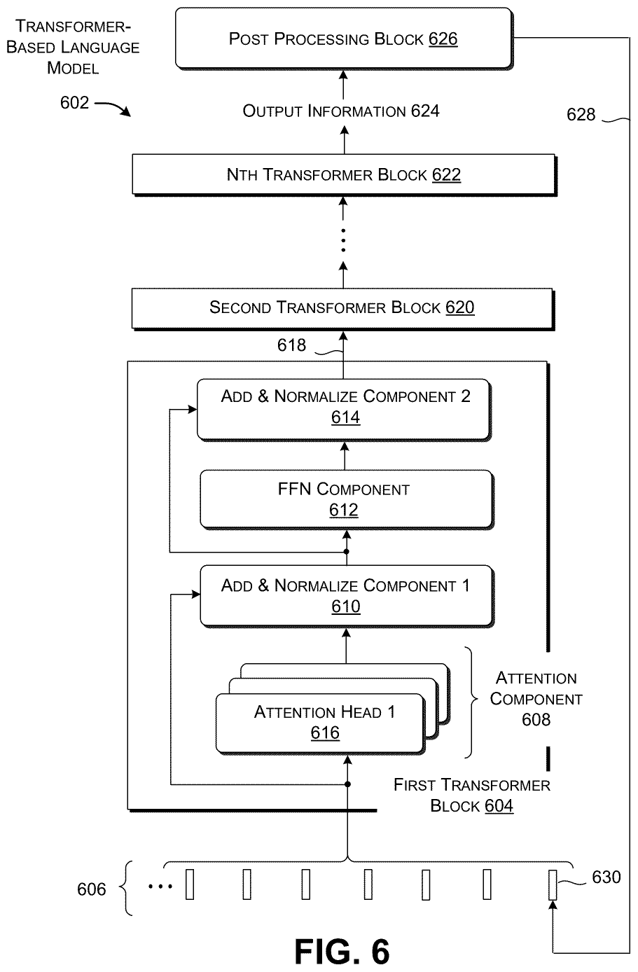

FIG. 6 shows a transformer-based language model (“language model”)602 for implementing the pretrained model 102 referenced by FIG. 1. The language model 602 is composed, in part, of a pipeline of transformer blocks, including a first transformer block 604. In the nomenclature of FIG. 1, the transformer blocks constitute the different model parts (104, 106, 108, . . . , 110). FIG. 6 provides details regarding one way to implement the first transformer block 604. Although not specifically illustrated, other transformer blocks of the language model 602 have the same architecture, perform the same functions, and produce the same-shaped output results (e.g., same-dimensioned output embeddings) as the first transformer block 604, but are governed by separate sets of weights.

The language model 602 commences its operation with the receipt of input information, such as a passage of text. The prompt includes a series of linguistic tokens. In some examples, a “token” refers to a unit of text having any granularity, such as an individual word, a word fragment produced by byte pair encoding (BPE), a character n-gram, a word fragment identified by the WordPiece or SentencePiece algorithm, etc. To facilitate explanation, assume that each token corresponds to a complete word. The principles set forth herein, however, are not limited to the processing of text information; in other examples, the language model 602 operates on any of: audio information, image information, video information, sensor information, and so on, or any combination thereof.

Next, an embedding component (not shown) maps the sequence of tokens into respective token embeddings. For example, the embedding component produces one-hot vectors that describe the tokens, and then maps the one-hot vectors into the token embeddings using a machine-trained transformation. The embedding component then adds position information (and, in some cases, segment information) to the respective token embeddings to produce position-supplemented embedding vectors 606. The position information added to each token embedding describes the embedding vector's position in the sequence of token embeddings.

The first transformer block 604 operates on the position-supplemented embedding vectors 606. In some implementations, the first transformer block 604 includes, in order, an attention component 608, a first add-and-normalize component 610, a feed-forward neural network (FFN) component 612, and a second add-and-normalize component 614.

The attention component 608 determines how much emphasis should be placed on parts of input information when interpreting other parts of the input information. Consider, for example, a sentence that reads: “I asked the professor a question, but he could not answer it.” When interpreting the word “it,” the attention component 608 will determine how much weight or emphasis should be placed on each of the words of the sentence. The attention component 608 will find that the word “question” is most significant.

The attention component 608 performs attention analysis using the following equation:

$$Attention ( Q , K , V ) = softmax ( \frac{{QK}^{T}}{\sqrt{{d}_{k}}} ) V . \qquad ( 1 )$$

The attention component 608 produces query information Q by multiplying the position-supplemented embedding vectors 606 by a query weighting matrix W^{Q}. Similarly, the attention component 608 produces key information K and value information V by multiplying the position-supplemented embedding vectors 606 by a key weighting matrix W^{K} and a value weighting matrix W^{V}, respectively. To execute Equation (1), the attention component 608 takes the product of Q with the transpose of K, and then divides the product by a scaling factor \sqrt{d}, to produce a scaled result. The symbol d represents the dimensionality of Q and K. The attention component 608 takes the Softmax (normalized exponential function) of the scaled result, and then multiplies the result of the Softmax operation by V, to produce attention output information. In some cases, the attention component 608 is said to perform masked attention insofar as the attention component 608 masks output token information that, at any given time, has not yet been determined. Background information regarding the general concept of attention is provided in Vaswani, et al., “Attention Is All You Need,” in 31st Conference on Neural Information Processing Systems (NIPS 2017), 2017, 11 pages.

Note that FIG. 6 shows that the attention component 608 is composed of plural attention heads, including a representative attention head 616. Each attention head performs the computations specified by Equation (1), but with respect to a particular representational subspace that is different than the subspaces of the other attention heads. To accomplish this operation, the attention heads perform the computations described above using different respective sets of query, key, and value weight matrices. Although not shown, the attention component 608 concatenates the output results of the attention component's separate attention heads, and then multiplies the results of this concatenation by another weight matrix W^{O}.

The add-and-normalize component 610 includes a residual connection that combines (e.g., sums) input information fed to the attention component 608 with the output information generated by the attention component 608. The add-and-normalize component 610 then normalizes the output information generated by the residual connection, e.g., by normalizing values in the output information based on the mean and standard deviation of those values, or by performing root-mean-squared normalization. The other add-and-normalize component 614 performs the same functions as the first-mentioned add-and-normalize component 610. The FFN component 612 transforms input information to output information using a feed-forward neural network having any number of layers.

The first transformer block 604 produces output information 618. A series of other transformer block (620, . . . , 622) perform the same functions as the first transformer block 604 and produce output results of the same shape (e.g., the same dimensions), each operating on output information produced by its immediately preceding transformer block. Each transformer block uses its own level-specific set of machine-trained weights. The final transformer block 622 in the language model 602 produces final output information 624.

In some implementations, a post-processing component 626 performs post-processing operations on the final output information 624. For example, the post-processing component 626 performs a machine-trained linear transformation on the final output information 624, and processes the results of this transformation using a Softmax component (not shown). The language model 602 uses the output of the post-processing component 626 to predict the next token in the input sequence of tokens. In some applications, the language model 602 performs this task using a greedy selection approach (e.g., by selecting the token having the highest probability), or by using the beam search algorithm (e.g., by traversing a tree that expresses a search space of candidate next tokens).

In some implementations, the language model 602 operates in an auto-regressive manner, as indicated by the loop 628. To operate in this way, the language model 602 appends a predicted token to the end of the sequence of input tokens, to provide an updated sequence of tokens. The predicted token leads to the production of a new position-supplemented vector 630. In a next pass, the language model 602 processes the updated sequence of position-supplemented vectors to generate a next predicted token. The language model 602 repeats the above process until it generates a specified stop token.

The above-described implementation of the language model 602 relies on a decoder-only architecture. Other implementations of the language model 602 use an encoder-decoder transformer-based architecture. Here, a transformer-based decoder receives encoder output information produced by a transformer-based encoder, together with decoder input information.

In other implementations, the post-processing component 626 represents a classification component that produces a classification result. In some implementations, the classification component is implemented by using a fully-connected feed-forward neural network having one or more layers followed by a Softmax component. A BERT-based transformer model is an example of this configuration. General background information on the BERT-based transformer model is provided in Devlin, et al., “BERT: Pre-training of Deep Bidirectional Transformers for Language Understanding,” arXiv, arXiv:1810.04805v2 [cs.CL], May 24, 2019, 16 pages.

In the context of FIGS. 1 and 2, the process 202 creates difference-based version of for each particular block under consideration (except for the case of the first transformer block 604) by subtracting a full set of weights associated with the particular transformer block and a full set of weights associated with a preceding transformer block. This manner of operation relies on the fact that the different transformer blocks produce output results of the same shape (e.g., the same dimensions), making different instances of the results directly comparable. A transformer-based model is just one kind of model which has this property. For instance, the process 202 can also successfully generate difference-based weights for convolutional blocks of some convolutional neural networks, some multi-layer perceptron networks, some recurrent neural networks, etc. The compression technique can also be applied to only part of a neural network having parts that produce same-dimensioned outputs.

### D. Expanding the Capabilities of the Compressed Model

In some implementations, the compressed model 214 produced by the process 202 of FIG. 2 is the entirety of the machine-trained model implemented by the computing device 302 of FIG. 3. In other examples, the compressed model 214 is just part of a more encompassing machine-trained model. This more encompassing model is referred to in this section as an expanded machine-trained model to help distinguish it from the compressed model 214, which is a part of the expanded machine-trained model. Aspects of the implementations described in this section represent a modification and extension of the systems and methods described in Fayyaz, et al., “Reducing Size of a Machine-Trained Model to Facilitate Storage and Transfer,” U.S. application Ser. No. 18/232,465 (the '465 application), filed on Aug. 10, 2023, 68 pages. The '465 application is incorporated herein by reference in its entirety.

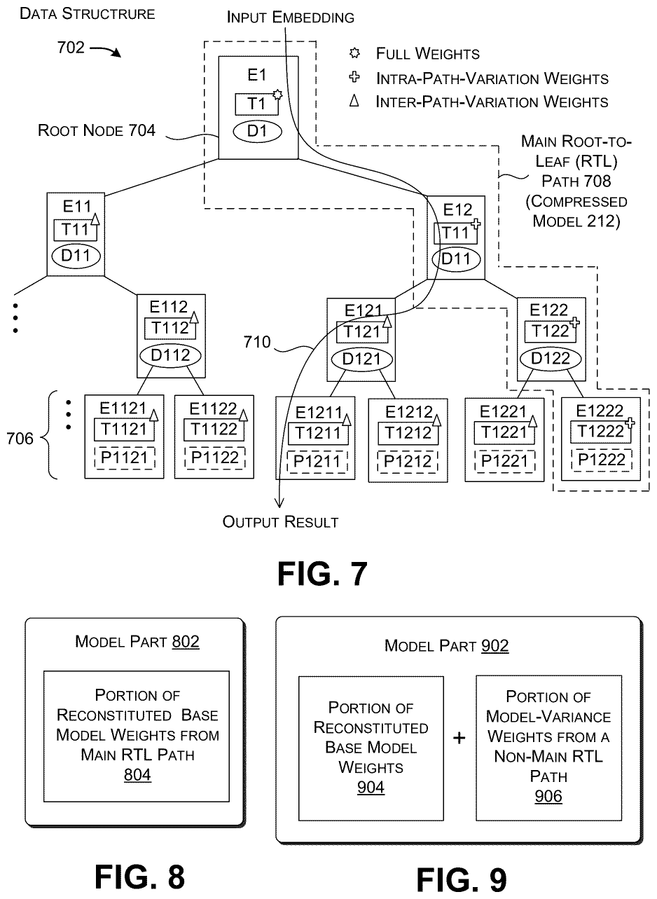

FIG. 7 shows a data structure 702 for representing the weights of the expanded machine-trained model according to some implementations. The data structure 702 includes a graph of nodes connected by links. Each node represents an instance of weights associated with a model part of the expanded machine-trained model. Each link represents a possible flow in the execution of model parts. The particular data structure 702 of FIG. 7 takes the form of a hierarchy of nodes.

An execution system (not shown) steps through the data structure 702 along a particular path. For example, the execution system first executes a model part that uses the weights information associated with a root node (E1) 704. The execution system then executes a model part associated with either node E11 or node E12, but not both. Assume that the execution system executes a model part associated with node E12. The execution system then executes a model part associated with node E121 or node E122, but not both. This process continues until the execution system executes a model part associated with a terminal (leaf) node of the tree, at which time the execution system provides a final output result. The leaf node is one of a plurality of leaf nodes 706.

There are plural possible paths that can be taken to traverse the data structure 702 from the root node (E1)704 to one of the leaf nodes 706, which referred to as root-to-leaf (RTL) paths. In the particular example of FIG. 7, a main RTL path 708 involves, in order, the traversal of the root node (E1) 704, node E12, node E122, and leaf node E1222. Other paths between the root node (E1) 704 and respective leaf nodes 706 are referred to as non-main RTL paths. An example of a non-main RTL path is path 710, which involves, in order, the traversal of nodes (E1) 704, E12, E121, and E1211. Note that any non-main RTL path includes one or more nodes that are shared with the main RTL path 708, including at least the root node (E1) 704.

The model parts in the main RTL path 708 constitute a base model, and the weights of model parts in the main RTL path 708 constitute instances of base model weights. At least one node along a non-main RTL path includes a portion of inter-path-variance weights. These labels are intended to describe the role of the weights in the data structure 702. That is, the qualifier “inter-path” in the term “inter-path-variance weights” means that the weights of a node in the non-main RTL path are defined in terms of their variance from a counterpart node in the main RTL path 708. “Base weights” are referred to as “base” because they are the basis by which inter-path-variance weights are interpreted. It can also be said that the base weights are not interpreted with reference to any node of the data structure 702 outside the main RTL path 708.

In some implementations, the base model of the main RTL path 708 is the compressed model 214. As such, the model parts that make up the main RTL path 708 use respective instances of reduced-dimension weights (with the exception of the anchor model part(s) in some implementations). Each such instance of reduced-dimension weights for a difference-based model part is also referred to as an instance of intra-path-variance weights. The qualifier “intra-path” in the term “intra-path-variance weights” means that the weights of any non-anchor node in the main RTL path 708 are defined in terms of their variance from the weights of a preceding model part in the same main RTL path 708, and, ultimately, the model weights of the anchor model part. In other words, “inter” in this context means between paths, while “intra” means within a path.

During execution of the expanded machine-trained model, the execution system executes a non-main RTL model part (e.g., at node E121) associated with an instance of inter-variance weights with reference to its corresponding full portion of base model weights in the main RTL path 708 (at node E122). To do this, the execution system first restores a reduced-dimension version of the intra-path-variance weights (at node E122) to its full counterpart (if not already reconstituted to its full form) in the manner described in Section B. The execution system then combines the restored set of full weights with the inter-variance weights of the non-main RTL model part under consideration (at node E121). Weight restoration or reconstruction, as the terms are used herein, occurs in the course of performing computations, and does not necessitate storing the full weights in memory.

As stated, the execution system executes an instance of base model weights without reference to any instance of weights in a non-main RTL path. Further, the execution system executes the instance of base model weights associated with the root node 704 without reference to any other node in the main RTL path 708.

A training system (not shown) trains the instances of inter-variance weights in the non-main RTL paths (which are not shared with the main RTL path 708) in end-to-end fashion, while keeping the base model weights fixed. In some examples, a developer uses this strategy to produce a machine-trained model that has more capabilities than the compressed model 214 acting alone. For example, assume that the original compressed model 214 performs a task X. A developer may wish to produce an expanded machine-trained model that is capable of performing tasks X, Y, and Z. When training is complete, the different leaf nodes 706 of the trained data structure 702 are associated with different portions of a response space. For instance, the leaf node (E1222) of the main RTL path 708 provides responses to input items directed to the original task X. The other leaf nodes may provide responses associated with responses Y and Z.

The training system does not dictate the path that any given input item takes in the data structure 702. Rather, the training system learns to direct particular input items to particular leaf nodes. The loss function of the training system only expects that a model-generated response agrees with a ground-truth response. Over a series of iterations, the training system adjusts the inter-path-variance weights based on the discrepancies between ground-truth responses and model-generated responses.

In one approach, the training system trains each portion of inter-variance-weights by decomposing a corresponding portion of base model weights (represented by a full weight matrix) into two smaller matrices. The training system then trains the reduced-sized matrices while keeping the base model weights fixed. When training is complete, the two smaller matrices constitute an instance inter-path-variance weights. Background information on the general topic of matrix decomposition in a training operation can found at Hu, at al., “LoRA: Low-Rank Adaptation of Large Language Models,” arXiv, arXiv:2106.09685v2 [cs.CL], Oct. 16, 2021, 26 pages.

In another approach, the training system adds one or more additional layers to a model part, referred to as an adapter. For example, the adapter is a fully-connected neural network placed on top of the model part. The training system then trains the model weights of the adapter(s), while holding the base model weights of the model part fixed. When training is complete, the weights of the adapter constitute an instance of inter-path-variance weights. General background information on the use of adapters can be found in: Houlsby, et al., “Parameter-Efficient Transfer Learning for NLP,” arXiv, arXiv:1902.00751v2 [cs.LG], June 2019, 13 pages; Pfeiffer, et al., “AdapterFusion: Non-Destructive Task Composition for Transfer Learning,” arXiv, arXiv:2005.00247v3 [cs.CL], Jan. 26, 2021, 17 pages; and Pfeiffer, et al., “AdapterHub: A Framework for Adapting Transformers,” in Proceedings of the 2020 Conference on Empirical Methods in Natural Language Processing: System Demonstrations, 2020, 9 pages.

Each instance of inter-path-variance weights is significantly smaller in size compared to its corresponding full base portion of model weights (once it is reconstituted). Likewise, each instance of intra-path weights is smaller in size than the model weights associated with an anchor part. As a consequence, the data structure 702 as a whole represents the expanded machine-trained model with significantly reduced size, compared to the case in which all nodes associated with the expanded machine-trained model are described by respective instances of full model weights. As a further consequence, a computing system can more efficiently store the data structure 702 (compared to the case in which all nodes in the data structure 702 are associated with base portions of model weights). For reasons described above, using fewer parameters in the main RTL path 708 also speeds up inference.

FIG. 8 shows a model part 802 that executes a portion of base model weights 804. FIG. 9 shows a model part 902 that executes a portion of base model weights 904 in conjunction with a portion of inter-path-variance weights 906. For example, in some implementations, the model part 902 executes weights produced by combining a first result produced using the instance of base model weights 904 with a second result produced using the portion of inter-path-variance weights 906. In other implementations, in advance of execution, an execution system combines the instance of base model weights 904 with the instance of inter-path-variance weights 906, and then executes an operation using the resultant set of combined model weights. As noted above, the weight processing operations of FIGS. 8 and 9 also involve reconstituting full versions of base model weights in the manner described in Section B (if not already full versions). None of these reconstitution actions necessitate formally committing full weights to memory.

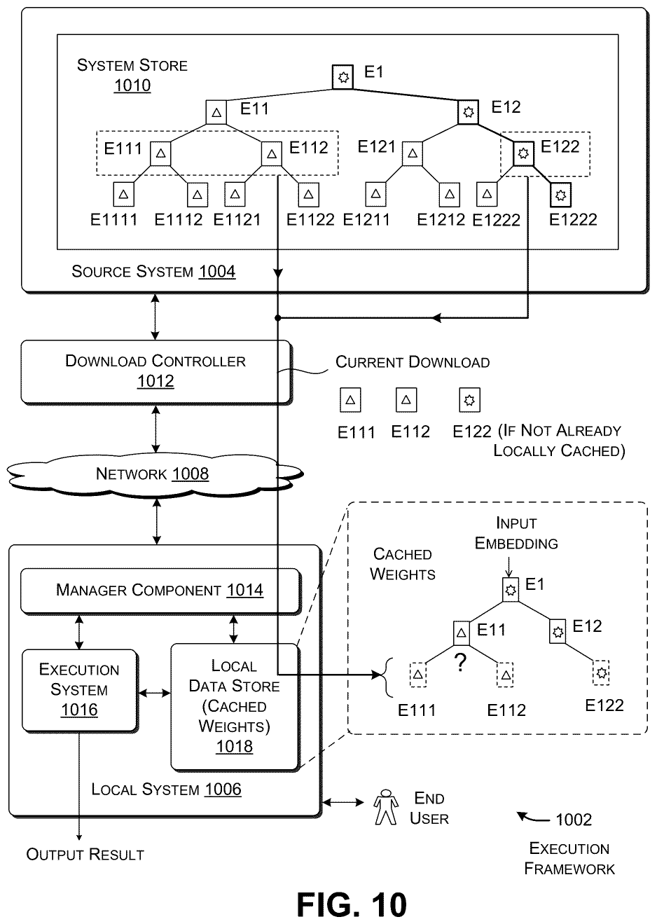

FIG. 10 shows an execution framework 1002 for downloading weights and executing operations based on the weights. A source system 1004 provides model weights to a local system 1006. The source system 1004 is implemented by one or more servers and/or other types of logic components. The local system 1006 includes one or more computing devices and/or other types of logic components, examples of which were described in Section B. In other implementations, the local system 1006 includes a group of local computing devices of any type(s) coupled together via a local network (not shown). The local system 1006 is communicatively coupled to the source system 1004 via a communication path. For example, the communication path is a network 1008 of any type, such as the Internet.

The source system 1004 includes a system store 1010 for storing model weights associated with an expanded machine-trained model, using the data structure 702 described above. To repeat, the data structure 702 includes a plurality of nodes. Each node is associated with an instance of weights used by a model part of the expanded machine-trained model. Some nodes are associated with instances of base model weights, which, in turn, are associated with the compressed model 214. Other nodes are associated with instances of inter-path-variance weights. The source system 1004 further includes (or is otherwise associated with) a download controller 1012 for serving portions of model weights to the local system 1006 upon request by the local system 1006 or, in some circumstances, in a push-based manner.

In some implementations, the local system 1006 includes a manager component 1014 for managing the execution of the expanded machine-trained model. As part of its responsibilities, the manager component 1014 interacts with the source system 1004 to successively request portions of model weights it does not already have. Execution system 1016 executes the expanded machine-trained model. In some implementations, the execution system 1016 includes program instructions that implement the expanded machine-trained model, e.g., by performing the computations required by the model.

A local data store 1018 stores the portions of model weights obtained from the source system 1004 and/or from some other source. The term “local store” is intended to broadly encompass any storage resources used by the local system 1006, and therefore encompasses both short-term and long-term storage resources. For instance, the memory resources of the local data store 1018 retain portions of the model weights during execution of the model parts corresponding to those portions. The long-term resources of the local data store 1018 optionally store frequently-used portions of model weights on a longer-term basis, eliminating the need to download these portions upon each execution of the expanded machine-trained model. Alternatively, or in addition, the local data store 1018 is preconfigured to store the base model nodes of the main RTL path 708, and even store some instances of intra-variance-path weights that are expected to be frequently used.

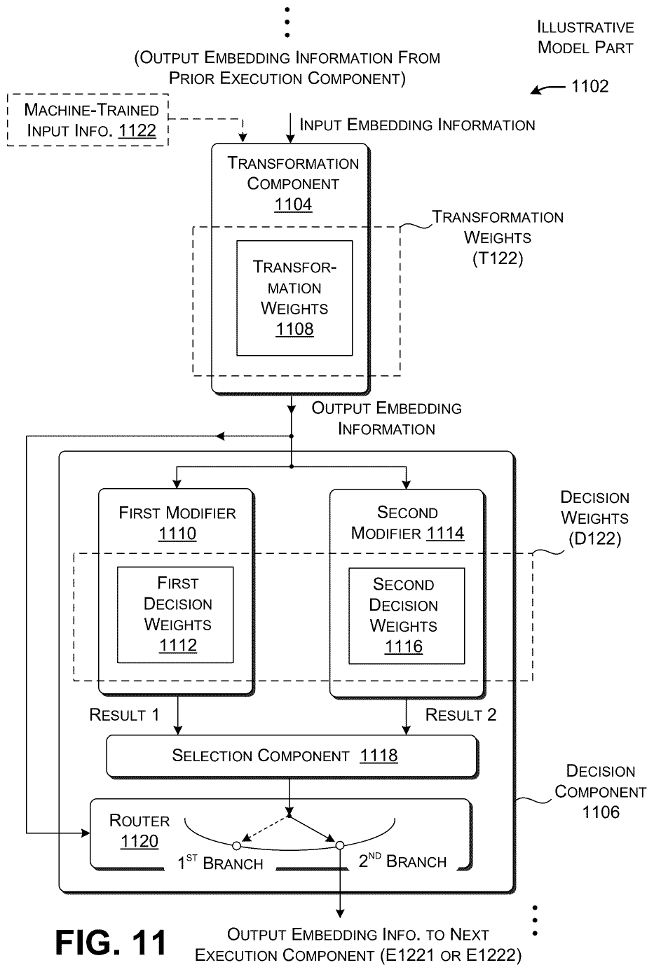

The execution system 1016 executes a series of model parts in the course of running the expanded machine-trained model. Each model part includes a transformation component and a decision component (except for a leaf execution component, which includes no decision component, but can include a post-processing component). The transformation component uses transformation weights to transform input embedding information into output embedding information. The decision component uses decision weights to decide what execution component to invoke next. The decision component then routes the output embedding information, produced by the transformation component, to the next model part. Additional details regarding the construction and operation of an illustrative execution component will be described below with reference to FIG. 11.

Each portion of model weights available in the system store 1010 includes a particular instance of transformation weights (designated by the symbol “T” in FIG. 7) and a particular instance of decision weights (designated by the symbol “D” in FIG. 7). For instance, the node labeled E122 includes particular transformation weights T122 and particular decision weights D122. Here, the instance of transformation weights is an instance of base model weights, which will be expanded to a full set of weights in the manner described in Section B. In other cases, the instance of transformation weights is an instance of inter-path-variance weights, which will be combined with a counterpart instance of base model weights (after the instance of base model weights is restored in the manner described in Section B). Each transformation component itself includes any neural network layer(s) for mapping input embeddings to output embeddings. In some implementations, the transformation component is a transformer block of a transformer-based neural network, but is not limited to this implementation.

Finally, FIG. 10 shows one manner of operation of the execution framework 1002 at a particular juncture in the execution of an expanded machine-trained model. Assume that the local system 1006 has already executed the model part associated with the node E1, and is currently in the process of executing the model part associated with the node E11. At this juncture, there are only two possibilities: the decision component of the node E11 will either invoke the model part associated with node E111 or node E112. To expedite the execution of the expanded machine-trained model, the manager component 1014 proactively requests instances of model weights for both node E112 and node E112, even before the decision component has decided which portions are to be used. In some implementations, after a routing decision has been made, the manager component 1014 purges the portions of model weights that were not used. Alternatively, the manager component 1014 proactively downloads more than two portions of model weights, such as the model weights associated with the nodes E111 and E112 together with the model weights associated with the children of these nodes (not shown in FIG. 7). Alternatively, the manager component 1014 waits until a decision has been made, and downloads the model weights for only the next selected model part (corresponding to either E111 or E112, but not both). Still other approaches are possible to govern what model portions are to be downloaded, and when the model portions are downloaded.

Both nodes E111 and E112 are associated with portions of inter-path-variance weights. To execute each instance of inter-path-variance weights, an execution component requires a corresponding base portion. Here, the portion of base model weights is the model weights associated with E122 of the main RTL path 708, which has the same level in data structure's hierarchy as nodes E111 and E112. (Note that this type of level-specific correspondence need not be true for all types of graphs.) In a first case, assume that the local data store 1018 already contains a copy of the portion of base model weights because the local data store 1018 was initialized to include all base model weights of the main RTL path 708, or the local system 1006 has previously downloaded and stored the required portions of base model weights. In this case, the manager component 1014 need only download the portions of inter-path-variance weights associated with the nodes E111 and E112. In a second case, assume that the local data store 1018 does not yet contain a copy of the instance of base model weights. In this case, the manager component 1014 downloads a copy of the instance of base model weights associated with node E122, as well as the instance of inter-path-variance weights for E111 and E112.

The manager component 1014 uses different rules to govern which model weights are retained in the local data store 1018 for potential reuse upon another execution of the expanded machine-trained model. In some cases, the manager component 1014 maintains model weights associated with the top nodes of the main RTL path 708, such as the model weights associated with nodes E1 and E12. Alternatively, or in addition, the manager component 1014 maintains model weights that are frequently requested by a particular user or group of users. To perform this function, the manager component 1014 maintains statistics that describe the frequency at which different model parts are used.

Overall, the execution framework 1002 reduces the amount of information that needs to be transferred from the source system 1004 to the local system 1006. This advantage follows from two provisions. First, the local system 1006 is able to request portions of model weights on an as-needed basis during the execution of the expanded machine-trained model. Because of this, the source system 1004 need only transfer a part of the model weights in the data structure 702, not the entirety of the model weights associated with all of its nodes. Second, the source system 1004 is capable of transferring the inter-path-variance and intra-path-variance weights with low latency because they are relatively small compared to respective instances of full weights.

FIG. 11 shows one implementation of model part 1102. Assume that the model part 1102 specifically uses the model weights of node E122 in the source system 1004. The model part 1102 includes a transformation component 1104 and decision component 1106. The transformation component 1104 uses transformation weights 1108 (e.g., transformation weights T122) to map an input embedding to output embedding information, including one or more embeddings. As used herein, an “embedding” represents information in numeric form, typically as a distributed vector. A distributed vector is a vector that expresses the meaning of information using a combination of its values. This is in contrast to a sparse one-hot vector in which each dimension of the vector is assigned a particular meaning. Except for the case of the first execution component, the input embedding information originates from an upstream execution component (in this example, the execution component for node E12). As noted above, in some implementations, the transformation component 1104 is a transformer block of a transformer-based language model.

In the example of FIG. 11, the transformation weights 1108 belong to node E122. Because node E122 belongs to the main RTL path 707, the transformation weights represent an instance of intra-path-variance weights that is expanded to a full set of weights in the manner described in Section B. In other examples, the transformation weights 1108 correspond to an instance of full weights that is produced by combining an instance of inter-path-variance weights with a counterpart instance of base model weights. The base model weights are also expanded to a full set of weights in the manner described in Section B.

The decision component 1106 includes a first modifier 1110 for mapping the output embedding information to a first result using first decision weights 1112, and a second modifier 1114 for mapping the output embedding information to a second result using second decision weights 1116. Together, the first decision weights 1112 and the second decision weights 1116 constitute the decision weights (e.g., D122) stored in the data structure 702. In some implementations, each modifier (1110, 1114) uses any type of neural network to perform its function, such as a fully-connected feed-forward neural network having one or more layers, followed by a Softmax function. A selection component 1118 identifies the next model part to invoke based on the first and second results. A router 1120 sends the output embedding information produced by the transformation component 1104 to the selected downstream model part.

In some implementations, the selection component 1118 makes a binary decision between a first routing path and a second routing path, e.g., by selecting the first routing path if the first result is greater in magnitude than the second result, and selecting the second routing path if the second result is greater in magnitude than the first result item. This is a “hard” multiplexing criterion, meaning that the selection component 1118 effectively assigns a probability of zero to all routing paths that have not been selected. If the first result equals the second result, then the selection component 1118 randomly chooses a routing a path, or always chooses the first routing path (or the second routing path), or makes a selection based on any other environment-specific rule.

In some implementations, the selection component 1118 implements the selecting operation using mapping logic. The mapping logic produces a mask that defines the probability associated with each possible path, which can be simplified to a value of “0” for a path that will not be taken, and a value “1” for a path that will be taken. The mapping logic multiplies the mask by the output embedding information of the transformation component 1104, which effectively achieves the routing of the output embedding information to a particular path.

### E. Illustrative Processes

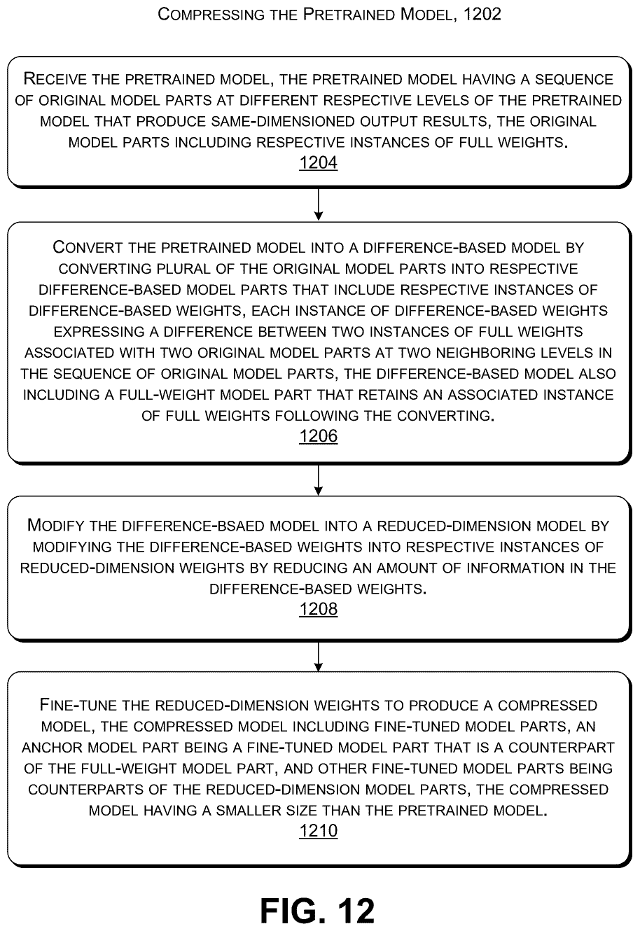

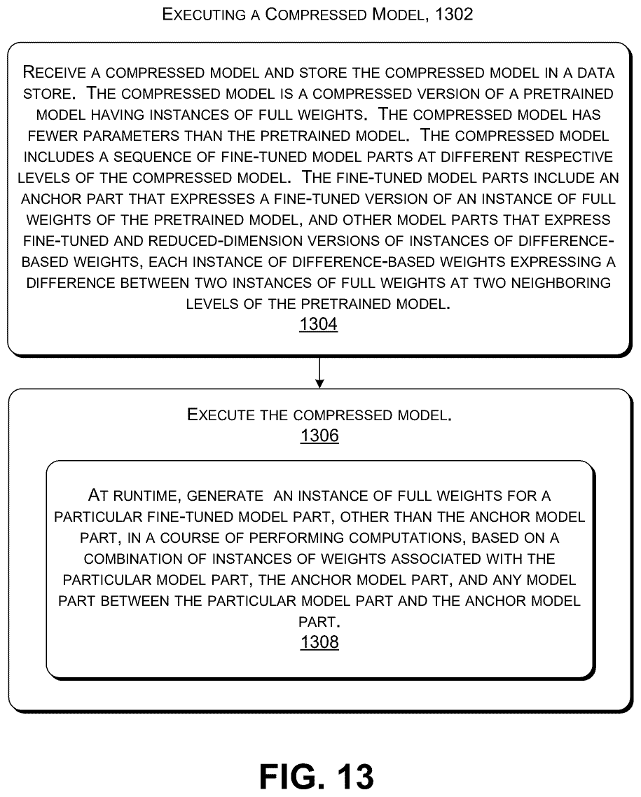

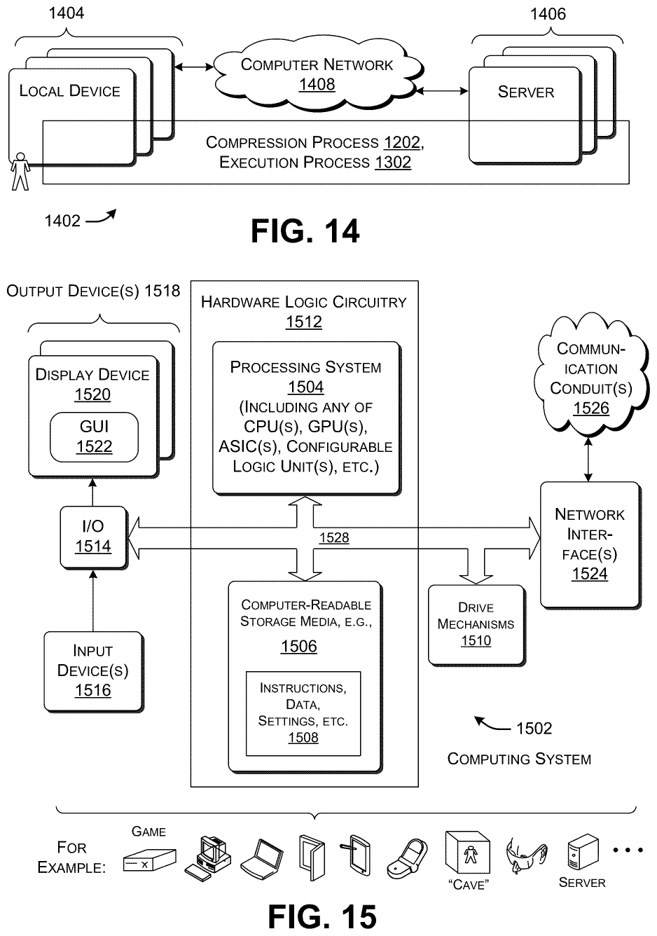

FIGS. 12 and 13 show two processes that represent an overview of the operation of the compression and execution mechanisms described above. Each of the processes is expressed as a series of operations performed in a particular order. But the order of these operations is merely representative, and the operations are capable of being varied in other implementations. Further, any two or more operations described below are capable of being performed in a parallel manner. In one implementation, the blocks shown in the processes that pertain to processing-related functions are implemented by the computing equipment described in connection with FIGS. 14 and 15.

More specifically, FIG. 12 shows a process 1202 for reducing the size of a pretrained model (e.g., the pretrained model 102). In block 1204, the compression system 1204 receives the pretrained model. The pretrained model has a sequence of original model parts at different respective levels of the pretrained model that produce same-dimensioned output results. The original model parts include respective instances of full weights. In block 1206, the compression system 1204 converts the pretrained model into a difference-based model by converting plural of the original model parts into respective difference-based model parts that include respective instances of difference-based weights. Each instance of difference-based weights expresses a difference between two instances of full weights associated with two original model parts at two neighboring levels in the sequence of original model parts. The difference-based model also includes a full-weight model part that retains an associated instance of full weights following the converting. In block 1208, the compression system 204 modifies the difference-based model into a reduced-dimension model by modifying the difference-based weights into respective instances of reduced-dimension weights by reducing an amount of information in the difference-based weights. In block 1210, the compression system 204 fine-tunes the reduced-dimension weights to produce a compressed model (e.g., the compressed model 214). The compressed model includes fine-tuned model parts. An anchor model part is a fine-tuned model part that is a counterpart of the full-weight model part. Other fine-tuned model parts are counterparts of the reduced-dimension model parts. The compressed model has a smaller size than the pretrained model and uses a fewer number of parameters compared to the pretrained model. In some implementations, the modifying of block 1208 is also applied to the full-weight model part.

FIG. 13 shows a process 1302 for executing a compressed model (e.g., the compressed model 214). Assume that a data store (e.g., the data store 304) of a computing device (e.g., the computing device 302) stores the compressed model, and that the compressed model is a compressed version of a pretrained model (e.g., the pretrained model 102) having instances of full weights. The compressed model also has fewer parameters than the pretrained model. In block 1304, the computing device 302 receives the compressed model and stores the compressed model in the data store. The compressed model includes a sequence of fine-tuned model parts at different respective levels of the compressed model. The fine-tuned model parts, in turn, include an anchor part that expresses a fine-tuned version of an instance of full weights of the pretrained model, and other model parts that express reduced-dimension and fine-tuned versions of instances of difference-based weights. Each instance of difference-based weights expresses a difference between two instances of full weights at two neighboring levels of the pretrained model. In block 1306, the computing device 302 executes the compressed model. In some implementations, the anchor model part, in addition to being fine-tuned, is also a reduced-dimension version of the full weights.

In some implementations, the computing device 302 implements block 1306 by the runtime operations in blocks 1308. That is, in block 1308, the computing device 302 generates an instance of full weights for a particular fine-tuned model part, other than the anchor model part, in a course of performing computations, based on a combination of instances of weights associated with the particular model part, the anchor model part, and any model part between the particular model part and the anchor model part. Execution of the compressed model involves fewer computations compared to the pretrained model because the compressed model has fewer parameters compared to the pretrained model. This speeds up execution.

### F. Illustrative Computing Systems

FIG. 14 shows computing equipment 1402 that, in some implementations, is used to implement the compression process 1202 of FIG. 12 or the execution process 1302 of FIG. 13. The computing equipment 1402 includes a set of local devices 1404 coupled to a set of servers 1406 via a computer network 1408. Each local device corresponds to any type of computing device, including any type of device mentioned above. In some implementations, the computer network 1408 is implemented as a local area network, a wide area network (e.g., the Internet), one or more point-to-point links, or any combination thereof.

The bottom-most overlapping box in FIG. 14 indicates that the functionality described above is capable of being spread across the local devices 1404 and/or the servers 1406 in any manner. In one example, the compression process 1202 is entirely implemented by a local device. In another example, the compression process 1202 is entirely implemented by the servers 1406. Here, a user is able to interact with the servers 1406 via a browser application running on a local device. In other examples, some operations of the compression process 1202 are implemented by a local device, and other operations of the compression process 1202 are implemented by the servers 1406. The same applies to the execution process 1302, meaning that it can be entirely implemented in local fashion by a local device, or can be entirely implemented by the servers 1406, or can be implemented in distributed fashion by both a local device and the servers 1406.

FIG. 15 shows a computing system 1502 that, in some implementations, is used to implement any aspect of the mechanisms set forth in the above-described figures. For instance, in some implementations, the type of computing system 1502 shown in FIG. 15 is used to implement any local computing device or any server shown in FIG. 14. In all cases, the computing system 1502 represents a physical and tangible processing mechanism.

The computing system 1502 includes a processing system 1504 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 1502 also includes computer-readable storage media 1506, corresponding to one or more computer-readable media hardware units. The computer-readable storage media 1506 retains any kind of information 1508, such as machine-readable instructions, settings, model weights, and/or other data. In some implementations, the computer-readable storage media 1506 includes one or more solid-state devices, one or more hard disks, one or more optical disks, etc. Any instance of the computer-readable storage media 1506 represents a fixed or removable unit of the computing system 1502. Further, any instance of the computer-readable storage media 1506 provides volatile and/or non-volatile retention of information. The specific term “computer-readable storage medium” or “storage device” expressly excludes propagated signals per se in transit; a computer-readable storage medium or storage device is “non-transitory” in this regard.

The computing system 1502 utilizes any instance of the computer-readable storage media 1506 in different ways. For example, in some implementations, any instance of the computer-readable storage media 1506 represents a hardware memory unit (such as random access memory (RAM)) for storing information during execution of a program by the computing system 1502, and/or a hardware storage unit (such as a hard disk) for retaining/archiving information on a more permanent basis. In the latter case, the computing system 1502 also includes one or more drive mechanisms 1510 (such as a hard drive mechanism) for storing and retrieving information from an instance of the computer-readable storage media 1506.

In some implementations, the computing system 1502 performs any of the functions described above when the processing system 1504 executes computer-readable instructions stored in any instance of the computer-readable storage media 1506. For instance, in some implementations, the computing system 1502 carries out computer-readable instructions to perform each block of the processes described with reference to FIGS. 12 and 13. FIG. 15 generally indicates that hardware logic circuitry 1512 includes any combination of the processing system 1504 and the computer-readable storage media 1506.

In addition, or alternatively, the processing system 1504 includes one or more other configurable logic units that perform operations using a collection of logic gates, such as field-programmable gate arrays (FPGAs), etc. In these implementations, the processing system 1504 effectively incorporates a storage device that stores computer-readable instructions, insofar as the configurable logic units are configured to execute the instructions and therefore embody or store these instructions.

In some cases (e.g., in the case in which the computing system 1502 represents a user computing device), the computing system 1502 also includes an input/output interface 1514 for receiving various inputs (via input devices 1516), and for providing various outputs (via output devices 1518). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1520 and an associated graphical user interface presentation (GUI) 1522. The display device 1520 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1502 also includes one or more network interfaces 1524 for exchanging data with other devices via one or more communication conduits 1526. One or more communication buses 1528 communicatively couple the above-described units together.

The communication conduit(s) 1526 is implemented in any manner, e.g., by a local area computer network, a wide area computer network (e.g., the Internet), point-to-point connections, or any combination thereof. The communication conduit(s) 1526 include any combination of hardwired links, wireless links, routers, gateway functionality, name servers, etc., governed by any protocol or combination of protocols.

FIG. 15 shows the computing system 1502 as being composed of a discrete collection of separate units. In some cases, the collection of units corresponds to discrete hardware units provided in a computing device chassis having any form factor. FIG. 15 shows illustrative form factors in its bottom portion. In other cases, the computing system 1502 includes a hardware logic unit that integrates the functions of two or more of the units shown in FIG. 15. For instance, in some implementations, the computing system 1502 includes a system on a chip (SoC or SOC), corresponding to an integrated circuit that combines the functions of two or more of the units shown in FIG. 15.

The following summary provides a set of illustrative examples of the technology set forth herein.

(A1) According to one aspect, a method (e.g., the method 1202) is described for reducing a size of a pretrained model (e.g., the pretrained model 102). The method includes: receiving (e.g., in block 1204) the pretrained model, the pretrained model having a sequence of original model parts at different respective levels of the pretrained model that produce same-dimensioned output results, the original model parts including respective instances of full weights; and converting (e.g., in block 1206) the pretrained model into a difference-based model (e.g., the difference-based model 120) by converting plural of the original model parts into respective difference-based model parts that include respective instances of difference-based weights. Each instance of difference-based weights expresses a difference between two instances of full weights associated with two original model parts at two neighboring levels in the sequence of original model parts. The difference-based model also includes a full-weight model part that retains an associated instance of full weights following the converting. The method also includes modifying (e.g., in block 1208) the difference-based model into a reduced-dimension model (e.g., the reduced-dimension model 138) by modifying the difference-based weights into respective instances of reduced-dimension weights by reducing an amount of information in the difference-based model parts; and fine-tuning (e.g., in block 1210) the reduced-dimension weights to produce a compressed model (e.g., the compressed model 214), the compressed model including fine-tuned model parts, an anchor model part being a fine-tuned model part that is a counterpart of the full-weight model part, and other fine-tuned model parts being counterparts of the reduced-dimension model parts. The compressed model has a smaller size than the pretrained model.

(A2) According to some implementations of the method of A1, the pretrained model is a transformer-based language model. The original model parts include a sequence of transformer blocks of the transformer-based language model.

(A3) According to some implementations of the methods of A1 or A2, the compressed model includes a single anchor model part provided at a root level of the compressed model.

(A4) According to some implementations of any of the methods of A1-A3, the compressed model includes two or more anchor model parts provided at different respective levels of the compressed model.

(A5) According to some implementations of any of the methods of A1-A4, the modifying uses singular value decomposition (SVD) to reduce the amount of information in the instances of difference-based weights. The SVD produces, for a particular instance of difference-based weights, and for a specified rank, a set of weight matrices. The method stores the set of matrices for the particular instance of difference-based weights instead of the particular instance of difference-based weights.

(A6) According to some implementations of any of the methods of A1-A5, the compressed model forms a root-to-leaf (RTL) path in a hierarchical data structure. The hierarchical data structure includes at least one other path that includes a model part having an instance of weights that is expressed in terms of variations from an associated fine-tuned model part in the RTL path.

(A7) According to some implementations of any of the methods of A1-A6, the method further includes: storing the compressed model in a data store of a computing device; and using the computing device to execute the compressed model.

(A8) According to some implementations of the method of A7, the computing device is a user computing device.

(A9) According to some implementations of the methods of A7 or A8, the using includes, at runtime, generating an instance of full weights for a particular fine-tuned model part, other than the anchor model part, in a course of performing computations, based on a combination of instances of weights associated with the particular model part, the anchor model part, and any model part between the particular model part and the anchor model part.

(A10) According to some implementations of the method of A9, the generating of the instance of full weights involves summing weights associated with different levels.

(A11) According to some implementations of the method of A10, the generating of the instances of full weights bypasses storage of the instance of full weights that are generated in memory.

(A12) According to some implementations of any of the methods of A9-A11, the anchor model part is provided at a root level of the compressed model.

(A13) According to some implementations of any of the methods of A9-A12, there are least two anchor model parts, and wherein at least one anchor model part is provided at an intermediary level of the compressed model between a root level and a leaf level of the compressed model.

(A14) According to some implementations of any of the methods of A1-A13, the modifying is also applied to the full-weight model part to reduce an amount of information in the full-weight model part.

(B1) According to another aspect, another method (e.g., the method 1302) is described for executing a compressed model (e.g., the compressed model 214). The method uses a data store (e.g., the data store 304) for storing computer-readable instructions (e.g., the instructions 1508) and the compressed model, the compressed model being a compressed version of a pretrained model (e.g., the pretrained model 102) having instances of full weights, and the compressed model having fewer parameters than the pretrained model. The method includes receiving (e.g., block 1304) the compressed model and storing the compressed model in the data store. The compressed model includes a sequence of fine-tuned model parts at different respective levels of the compressed model. The fine-tuned model parts include an anchor part that expresses a fine-tuned version of an instance of full weights of the pretrained model, and other model parts that express fine-tuned and reduced-dimension versions of instances of difference-based weights. Each instance of difference-based weights expresses a difference between two instances of full weights at two neighboring levels of the pretrained model. The method also includes executing (e.g., in block 1306) the compressed model.

(B2) According to some implementations of the method of B1, the anchor model part, in addition to being fine-tuned, is a reduced-dimension version of the instance of full weights of the pretrained model.

(C1) According to another aspect, another method is described for executing a compressed model (e.g., in block 214). The method includes receiving (e.g., in block 1304) the compressed model, the compressed model being a compressed version of a pretrained model (e.g., the pretrained model 102) having instances of full weights. The compressed model has fewer parameters than the pretrained model. The compressed model also includes a sequence of fine-tuned model parts at different respective levels of the compressed model. The fine-tuned model parts include an anchor part that expresses a fine-tuned version of an instance of full weights of the pretrained model, and other model parts that express fine-tuned and reduced-dimension versions of instances of difference-based weights. Each instance of difference-based weights expresses a difference between two instances of full weights at two neighboring levels of the pretrained model. The method further includes, at runtime, generating (e.g., in block 1306) an instance of full weights for a particular fine-tuned model part, other than the anchor model part, in a course of performing computations, based on a combination of instances of weights associated with the particular model part, the anchor model part, and any model part between the particular model part and the anchor model part.

(C2) According to some implementations of the method of C1, the anchor model part, in addition to being fine-tuned, is a reduced-dimension version of the instance of full weights of the pretrained model.

In yet another aspect, some implementations of the technology described herein include a computing system (e.g., the computing system 1502) that includes a processing system (e.g., the processing system 1504) having a processor. The computing system also includes a storage device (e.g., the computer-readable storage media 1506) for storing computer-readable instructions (e.g., the information 1508). The processing system executes the computer-readable instructions to perform any of the methods described herein (e.g., any individual method of the methods of A1-A14, B1, B2, C1, or C2).

In yet another aspect, some implementations of the technology described herein include a computer-readable storage medium (e.g., the computer-readable storage media 1506) for storing computer-readable instructions (e.g., the information 1508). A processing system (e.g., the processing system 1504) executes the computer-readable instructions to perform any of the operations described herein (e.g., the operations in any individual method of the methods of A1-A14, B1, B2, C1, or C2).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted. Further, any features described as alternative ways of carrying out identified functions or implementing identified mechanisms are also combinable together in any combination, unless otherwise noted.

In terms of specific terminology, the phrase “configured to” encompasses various physical and tangible mechanisms for performing an identified operation. The mechanisms are configurable to perform an operation using the hardware logic circuitry 1512 of FIG. 15. The term “logic” likewise encompasses various physical and tangible mechanisms for performing a task. For instance, each processing-related operation illustrated in the flowcharts of FIGS. 12 and 13 corresponds to a logic component for performing that operation.

Further, the term “plurality” or “plural” or the plural form of any term (without explicit use of“plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. The term “prescribed” is used to designate that something is purposely chosen according to any environment-specific considerations. For instance, a threshold value or state is said to be prescribed insofar as it is purposely chosen to achieve a desired result. “Environment-specific” means that a state is chosen for use in a particular environment. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for reducing a size of a pretrained model, comprising:
receiving the pretrained model, the pretrained model having a sequence of original model parts at different respective levels of the pretrained model that produce same-dimensioned output results, the original model parts including respective instances of full weights;
converting the pretrained model into a difference-based model by converting plural of the original model parts into respective difference-based model parts that include respective instances of difference-based weights,
each instance of difference-based weights expressing a difference between two instances of full weights associated with two original model parts at two neighboring levels in the sequence of original model parts,
the difference-based model also including a full-weight model part that retains an associated instance of full weights following the converting;
modifying the difference-based model into a reduced-dimension model by modifying the difference-based weights into respective instances of reduced-dimension weights by reducing an amount of information in the difference-based model parts; and
fine-tuning the reduced-dimension weights to produce a compressed model, the compressed model including fine-tuned model parts, an anchor model part being a fine-tuned model part that is a counterpart of the full-weight model part, and other fine-tuned model parts being counterparts of the reduced-dimension model parts,
the compressed model having a smaller size than the pretrained model.

2. The method of claim 1, wherein the pretrained model is a transformer-based language model, and wherein the original model parts include a sequence of transformer blocks of the transformer-based language model.

3. The method of claim 1, wherein the compressed model includes a single anchor model part provided at a root level of the compressed model.

4. The method of claim 1, wherein the compressed model includes two or more anchor model parts provided at different respective levels of the compressed model.

5. The method of claim 1,
wherein the modifying uses singular value decomposition (SVD) to reduce the amount of information in the instances of difference-based weights,
wherein the SVD produces, for a particular instance of difference-based weights, and for a specified rank, a set of weight matrices, and
wherein the method stores the set of matrices for the particular instance of difference-based weights instead of the particular instance of difference-based weights.

6. The method of claim 1,
wherein compressed model forms a root-to-leaf (RTL) path in a hierarchical data structure, and
the hierarchical data structure includes at least one other path that includes a model part having an instance of weights that is expressed in terms of variations from an associated fine-tuned model part in the RTL path.

7. The method of claim 1, further comprising:
storing the compressed model in a data store of a computing device; and
using the computing device to execute the compressed model.

8. The method of claim 7, wherein the using comprises, at runtime:
generating an instance of full weights for a particular fine-tuned model part, other than the anchor model part, in a course of performing computations, based on a combination of instances of weights associated with the particular model part, the anchor model part, and any model part between the particular model part and the anchor model part.

9. The method of claim 8, wherein the generating of the instance of full weights involves summing weights associated with different levels.

10. The method of claim 8, wherein the generating of the instances of full weights bypasses storage of the instance of full weights that are generated in memory.

11. The method of claim 8, wherein, the anchor model part is provided at a root level of the compressed model.

12. The method of claim 8, wherein there are least two anchor model parts, and wherein at least one anchor model part is provided at an intermediary level of the compressed model between a root level and a leaf level of the compressed model.

13. The method of claim 1, wherein the modifying is also applied to the full-weight model part to reduce an amount of information in the full-weight model part.

14. A computing system for executing a compressed model, comprising:
a data store for storing computer-readable instructions and the compressed model, the compressed model being a compressed version of a pretrained model having instances of full weights, and the compressed model having fewer parameters than the pretrained model; and
a processing system for executing the computer-readable instructions in the instruction data store, to perform operations including:
receiving the compressed model and storing the compressed model in the data store,
the compressed model including a sequence of fine-tuned model parts at different respective levels of the compressed model,
the fine-tuned model parts including an anchor part that expresses a fine-tuned version of an instance of full weights of the pretrained model, and other model parts that express fine-tuned and reduced-dimension versions of instances of difference-based weights,
each instance of difference-based weights expressing a difference between two instances of full weights at two neighboring levels of the pretrained model; and
executing the compressed model.

15. The computing system of claim 14, wherein the executing comprises, at runtime:
generating an instance of full weights for a particular fine-tuned model part, other than the anchor model part, in a course of performing computations, based on a combination of instances of weights associated with the particular model part, the anchor model part, and any model part between the particular model part and the anchor model part.

16. The computing system of claim 15, wherein the generating of the instance of full weights involves summing weights at different levels.

17. The computing system of claim 15, wherein the generating of the instances of full weights bypasses storage of the instance of full weights that are generated in memory.

18. The computing system of claim 14, wherein the anchor model part is provided at a root level of the compressed model.

19. The computing system of claim 14, wherein there are least two anchor model parts, and wherein at least one anchor model part is provided at an intermediary level of the compressed model between a root level and a leaf level of the compressed model.

20. A computer-readable storage medium for storing computer-readable instructions, a processing system executing the computer-readable instructions to perform operations, the operations comprising each of:
receiving the compressed model;
the compressed model being a compressed version of a pretrained model having instances of full weights, and the compressed model having fewer parameters than the pretrained model, and the compressed model including a sequence of fine-tuned model parts at different respective levels of the compressed model,
the fine-tuned model parts including an anchor part that expresses a fine-tuned version of an instance of full weights of the pretrained model, and other model parts that express fine-tuned and reduced-dimension versions of instances of difference-based weights,
each instance of difference-based weights expressing a difference between two instances of full weights at two neighboring levels of the pretrained model; and
at runtime, generating an instance of full weights for a particular fine-tuned model part, other than the anchor model part, in a course of performing computations, based on a combination of instances of weights associated with the particular model part, the anchor model part, and any model part between the particular model part and the anchor model part.
